(19) United States
(12) Patent Application Publication
(10) Pub. No.: US 2021/0162570 A1
(43) Pub. Date: Jun. 3, 2021

(54) TOOL FOR TIGHTENING OR LOOSENING DIFFERENT ELEMENTS UNIDIRECTIONALLY, REGARDLESS OF THE DIRECTON OF ROTATION OF THE INPUT SHAFT (DOUBLE-RATCHET WRENCH)

(71) Applicant: Marco Antonio RODRIGUEZ RAMIREZ, Las Palmas (ES)

(72) Inventor: Marco Antonio RODRIGUEZ RAMIREZ, Las Palmas (ES)

(21) Appl. No.: 17/048,648

(22) PCT Filed: Apr. 16, 2019
(86) PCT No.: PCT/ES2019/000032

§ 371 Date: Oct. 19, 2020

(30) Foreign Application Priority Data
Apr. 17, 2018 (ES) U201800233

(51) Int. Cl. B25B 17/02; B25B 13/46

(52) U.S. Cl. CPC B25B 17/02; B25B 13/467; B25B 13/468

(57) ABSTRACT

A tool for tightening or loosening different elements unidirectionally, regardless of the direction of rotation of the input shaft (double-ratchet wrench). Includes a tool or tool accessory which can tighten or loosen screws unidirectionally, regardless of the direction of rotation applied at an input shaft (1), thereby reducing the number of movements required for existing tools to tighten or loosen, for example, a screw. The tool includes a casing (13) containing technology of the type used in energy converters, configured to convert movements in different rotational directions, applied at an input shaft (1), into unidirectional rotational movements at an output shaft (2), which is parallel to the input shaft; and is disposed such that a cutting plane can be drawn through the middle of the shafts, leaving the shaft ends (3.1, 3.2, 3.3, 3.4) visible or outside the casing, with the particularity that it is possible to couple to the input shaft at one end (3.1) or the other (3.2), given that, depending on the end of the input shaft used, the elements coupled to the output shaft (2) will rotate in opposite directions and unidirectionally at each end (3.3 and 3.4) thereof, depending whether a screw is being tightened or loosened.

### CROSS REFERENCE TO RELATED APPLICATION

This application is a national stage entry of PCT/ES2019/000032 filed Apr. 16, 2019, under the International Convention and claiming priority over Spain Patent Application No. U201800233 filed Apr. 17, 2018.

### DESCRIPTION

Tool for tightening or loosening different elements unidirectionally, regardless of the direction of rotation of the input shaft (double-ratchet wrench).

### TECHNICAL FIELD

The main field of application of this utility model is hand tools.

The object of this utility model is to have a tool with an input shaft and an output shaft, which generally serves to tighten or loosen screws and lights, so that a rotational movement is made in using the input shaft. Regardless of the direction of rotation to be applied, the output shaft outputs a one-way rotational movement for tightening or loosening, as desired.

### BACKGROUND OF THE INVENTION

This tool was created considering to two types different background requirements, those for existing manual hand tools and the existing background for the energy converter systems.

With respect to the manual tools we found that the ratchets keys are hand tools having one end with a male square, to which a vessel of different measures is coupled with a female connection, for tightening or loosening, for example screws, without the need to lift the tool from the tightening area, thereby having the author of this utility model called unidirectional coupling devices, but are commonly called freewheeling devices such as one way clutch bearings or with interlocking nails such as those used in the bicycle wheels, which, leave the drive key to effect tightening movement on the head of a screw, when the carriage key is moved in a direction, and which. When the carriage key is moved, in the contrary to the previous one, it makes it freely, without any tightening movement so that the two movement movements of the tightening tool are not being used.

On the other hand, there are energy converting systems which can convert rotational movements of a shaft to specific directions, applied on an input shaft, in a rotary motion an one way rotation of an output shaft. Example of this, we have U.S. Pat. No. 6,819,810 B1, WO2011131188, WO2014028782, etc. In these energy conversion systems, due to their configuration, the input and/or output shafts do not have two ends in which they engage and disengage the elements acting on said shafts. This allows them to be reversible, as the direction of rotation of the output shaft cannot be chosen manually without changes to the mechanics of the tool.

The invention relates to an universal power converter system which is more suitable for carrying out said utility model, and consists of an input shaft in which the forces and an output shaft are applied to which the elements are coupled to move, in addition, between the two shafts there are gears with freewheeling devices, which are arranged in the manner described in said patent, allowing a rotation movement to be applied to the input shaft in opposite directions, said movement is transmitted to the output shaft so that it rotates unidirectionally. In order to understand the concept of this energy conversion system WO20158948, we see in FIG. 1 of said patent that the conversion system has two parallel axes, one input (1′) and another output (2′) between them there is a transmission system comprised of gears and freewheeling devices arranged so that, when on the input shaft (1′) is moved by rotating, for example, to the right, a sprocket (3′) placed on the input shaft transmits the movement to another sprocket (5′) placed on the output shaft causing it to rotate in a direction opposite to that of the input shaft (1′).

When the input shaft rotates in the opposite direction, in this case, in this case, to the left, this input shaft will move the sprocket or pinion type gear (4), located on said shaft, transmitting the movement by means of a chain (9′) to another pinion type gear (6′), disposed on the output shaft, thereby moving the output shaft (2′) also to the left or, in the same direction of rotation as the input shaft (1′).

The placement and configuration of the upper wheel devices (7c′ and 7b′) of said patent of the invention are arranged in such a way that the system is not blocked, and permits the movements of the left to right rotation or vice versa of the input shaft independently between them to achieve an unidirectional rotational movement on the output shaft.

The Patent WO20158948 also shows in FIG. 2 another way to perform the same; this invention relates uses to an energy converter using to turn a reversing gear (15a). This new utility model, which is presented new tool, uses this energy converter system and its configuration of two or similar wheel devices to turn an inverter and two free wheel devices, for example, configured as in FIG. 1 of said patent of the invention.

### EXPLANATION OF THE INVENTION

This utility model refers to a tool allows the user to take advantage of either clockwise or anticlockwise two possible movements of rotations to take advantage, either from right to left or upside down, applied on an input shaft, so that these movements are transmitted to an shaft of input, so that such movements are transmitted to an output shaft using the technology of the power converters, so that an unidirectional movement is achieved on an output shaft, This can be used to tighten and or loosen screws or nuts, thus improving efficiency with respect over other tools, furthermore this new tool presented is reversible, since it allows the two ends or points of the input shaft and the output shaft to take advantage in order to position or couple the different elements, external to the tool, at any time and according to themselves, either for tightening and loosening.

In order to make this utility model, it is considered to be more suitable, the technology of the invention WO2015158946 or the like, however, has a number of drawbacks. The invention also relates to the input and output cylindrical shafts of the patent WO20158946 are offset with respect to each other (see FIG. 1 of said patent). The ends of the input or output shaft are not differentiated and, if set forth in FIG. 1 of said patent, in which a conversion system is seen within a casing (8′). That if the casing is placed around the energy conversion system, leaving the ends or points of both axes outside the housing, it would not be symmetrical, since it has one end of the input shaft and the output shaft shorter along one side of the housing than on the other hand, so that, if a tool handle is provided for coupling to the shorter end of the input shaft of this object that is to be formed with the housing (8′). Depending on the handle used with the output shaft in order to make a full 360 degree turn, and it would pass along the length of the shafts, since the input shaft is generally the input shaft, and depending on the handle used to move the tool, it must be slightly longer than the output shaft; for in order to solve this, the new utility model presented herein has a new arrangement of the axes, wherein the input shaft must generally be longer than the output shaft, and in addition the input and output assemblies will be arranged so that they are parallel, but so that they can use a cross sectional plane that part of the middle of said shafts

In order to move the input shaft of the new tool, presented in this utility model, a handle is needed, although any other system, such as a fixed key, can be used as a fixed key, so that, in this new utility model, the input shaft and the output shaft have two ends with a box or male bit, which can be a key, a female or mixed box.

In order to be able to use the existing tool handles, and as these, they generally have a pin or male bit at their ends, a new female adapter is used which is positioned between the end of the input shaft and the handle of the tool.

In order to move the input shaft, a new tool handle can also be used with a box or female bit, rather than the handles with existing male frames.

This invention is reversible, meaning that it serves both to tighten and loosen. If we have the following way, if we want to tighten a screw, we put a tool handle coupled at one of the ends of the input shaft, and at the lower end, but at the output shaft, the input shaft is provided with the input shaft moving the handle of the tool to Both the right and the left, the end with the drive key cup of the output shaft rotates to the right, tightening it.

If we want to loosen, we turn the tool designed in this utility model, and we will place the handle of the tool, coupled to the opposite end of the input shaft where it was previously located: we also place the ratchet socket in the opposite end of the output shaft, from where it was previously located. Now, when we move the input shaft by moving the handle of the tool both to the right and to the left, the end with the ratchet socket of the output shaft will rotate to the left, loosening.

Therefore, the tool of this invention is formed by a energy converter system configured to convert the movements of different rotational directions applied to the input shaft in an one way rotational motion of an output shaft and consists of two cylindrical shafts arranged in a parallel manner and so that

The invention also relates to a cross section plane that is part of the two axes (if it is cut transversely to the half of the tool formed, this cut to half, the two axes and the carcass), one of the shafts being the input shaft, is generally longer than the output shaft, and has at its ends a male or female key box or socket or cup although other types of couplings can be used.

The other of the shafts is the output shaft and has at its ends a male or female square frame of trolley or socket keys, although other types of couplings may be used, such as, for example, the couplings of drivers with carriages which are hexagonal (hexagonal shaped female connections or couplings) or those used in the torx keys.

Between the two shafts, there is a transmission means comprised of gears and free wheels, all configured to convert the rotation of different directions of the input shaft in a movement of a single direction of rotation on an output shaft.

This tool, object of this utility model, also presents a new handle in order to rotate the input shaft, or may be adapted to use the existing handles.

### BRIEF DESCRIPTION OF THE DRAWINGS

In order to complement and better understand this patent, the invention is accompanied by 7 figures which have an illustrative and non-limiting character:

FIG. 0 shows an example of an energy conversion system belonging to patent WO2015158946 corresponding to FIG. 1 thereof. In FIG. 1, we see a perspective of the object.

FIG. 1, shows a perspective of the object.

FIG. 2 shows a perspective view of the object with four male couplings.

FIG. 3, shows a perspective view of a new handle with a specific female bit for the double wrench.

FIG. 4, shows a perspective view of the axes with the centers parallel.

FIG. 5, shows a perspective view of a new socket with a socket coupling

FIG. 6, shows a perspective view of a socket wrench female-female adapter.

### PREFERRED EMBODIMENT OF THE INVENTION

In order to understand this tool, there is shown a figure of the energy conversion system such as that of the Patent WO2015158948, in which it is shown as having two parallel axes, one being one of input (1′) and another output (2′), between them, there is a transmission system comprised of gears and free loop devices, configured so that when on the input shaft (1′), it is moved by rotating, for example, to the right, the sprocket (3) transmits the movement to the other gear (5′), causing the output shaft (2) to rotate in a direction counter to that of the input shaft (1′).

When there are the input shaft, turning counterclockwise, in this case to the left, it will move the sprocket or pinion type gear (4′) by transmitting the movement by means of the chain (9′) to another pinion type gear (6′) thereby moving the output shaft (2′) also to the left, either in the same direction of rotation as the input shaft (1′).

The placement and configuration of the freewheeling devices (7c′ and 7b′), are arranged so that the system is not blocked and allows to perform the above described movements independently of them.

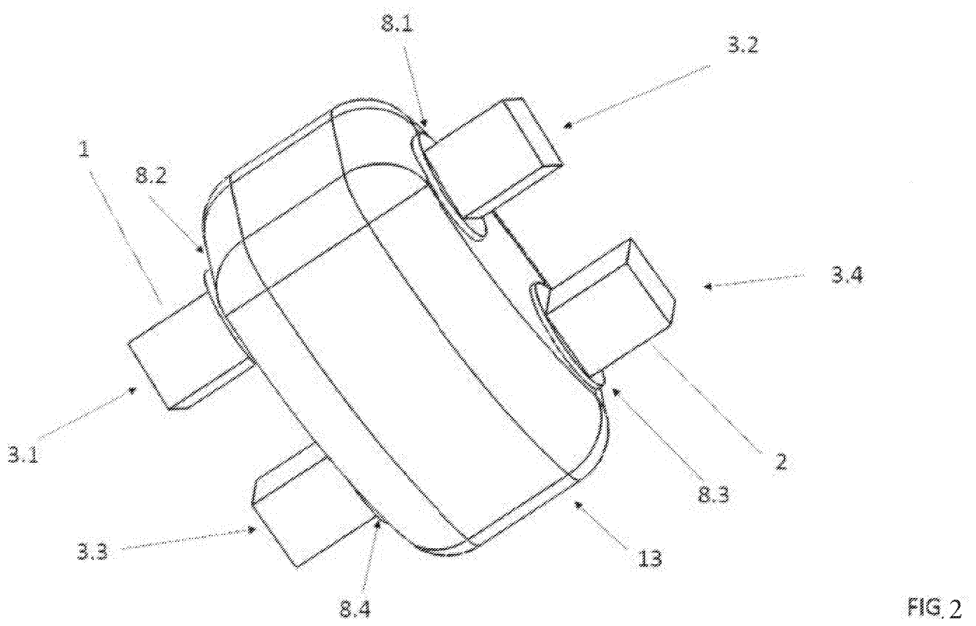

For a preferred embodiment, shown in FIG. 2, there is a tool object of this invention with a housing (13) for manual gripping which is divided into two parts, an upper and a lower part, which is closed with screws having four openings (8.1,8.2, 8.3,8.4) by which the input (1′) and output (2) axes are running. In order to facilitate rotation of the shafts, it has four idler rotation bearings in each of those openings (not shown), but although other systems exist for facilitating the rotation of the shafts, they may not carry none.

Said housing also provides an access to the upper part of the housing by means of introducing a lubricating fluid for the gears, and at the joint joints of the two parts of the housing to have sealing material. Internally, it is found that we call a power converter, which is reversible, and has an arrangement of its elements in the manner described above or the like (which performs the same function), configured to convert rotational movements of different directions, applied to an input shaft (1), in an one way rotational motion of an output shaft (2), comprised of sprockets, sprockets, chains, by free wheeling devices, or a system such as a bicycle having the sound of ratchet by the hooking claw, not shown in the figure.

The existing ratchet keys are commonly referred to as a sound bearing

The tool rotates the tool when it rotates freely in one of the directions. As can be seen in the patent No. WO2015158946. These uses at least two free wheeling devices, if these devices use an end axle nail, the tool object of this invention will cause noise in the two directions of rotation of the input shaft, so that the invention is commonly referred to as a double-ratchet wrench key to the tool of this invention, in the case of using clutch bearings since they do not make this noise

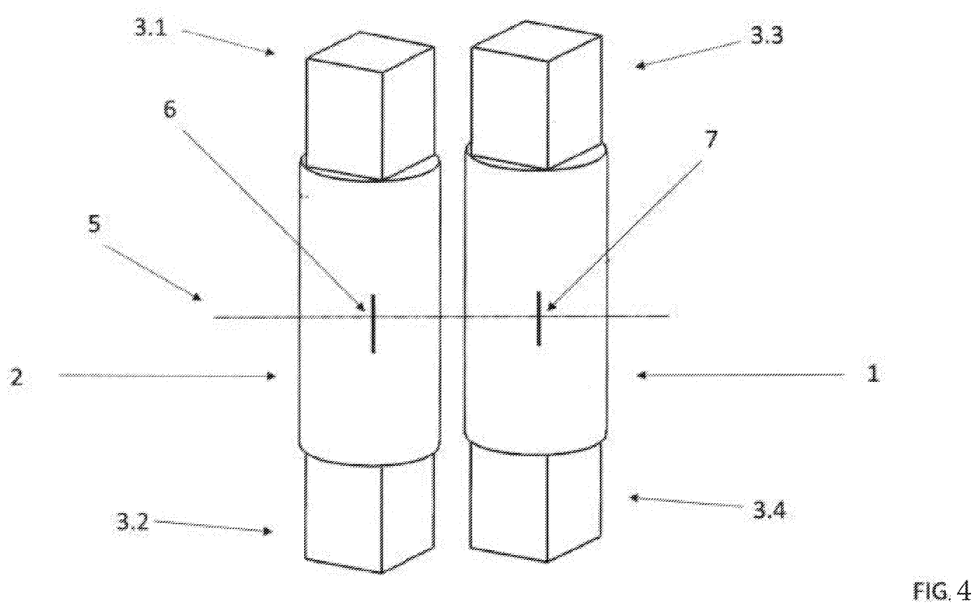

This tool has two parallel shafts (1 y 2) arranged so that the two axes can be cut in half by drawing a transverse cutting plane. FIG. 4), one of the shafts, is the input shaft (1) and the other of the axes, is if output (2) (see explanation in the description of FIG. 4). Preferably, the input shaft (1) can be slightly longer than the output shaft so that the handle does not interfere with said shaft (2), depending on the type of connection or coupling, although they can have the same measure.

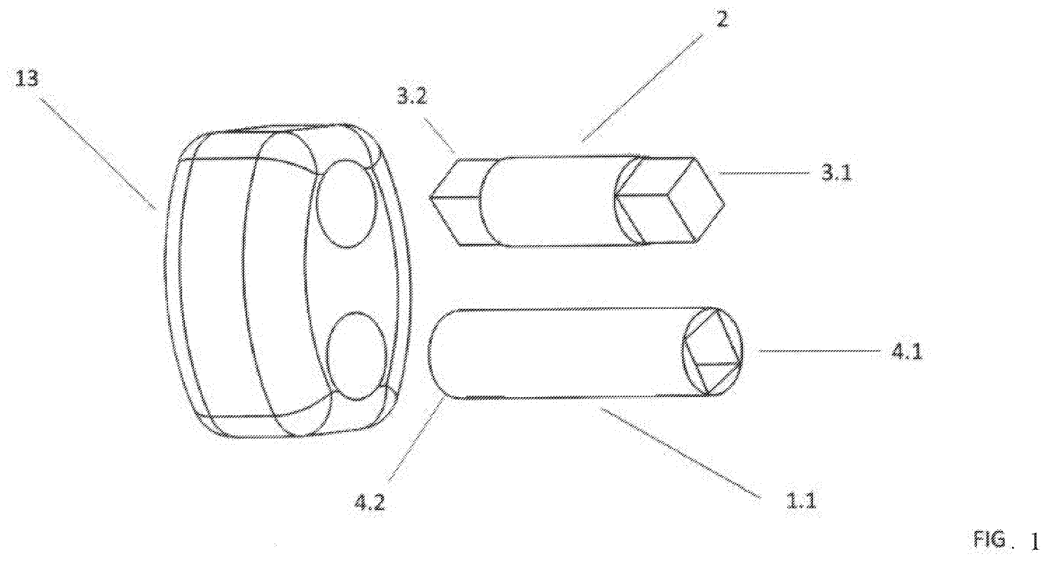

For this embodiment of FIG. 1, the input shaft (1.1) has a socket or female key bit at each end thereof

For this embodiment of the invention, the output shaft (2) has a male key plug in each end.

The operation of this tool is the following, if we want to tighten a screw, we put a handle with a male connector at one of the ends (4.1) of the input shaft (1.1) and a key cup in the opposite end (3.2) of the output shaft (2), while moving the input shaft (1.1) to one side, a movement transmission means belonging to the power converter disposed between the input shaft and the output shaft consisting of gears and an one way coupling device, such as a free wheel or a system with locking pawl like that of a bicycle, drives the output shaft (2) in the same direction of rotation as the input shaft (1), moving the screw when moving with the handle placed on the input shaft (1) in the opposite direction to the front, another means for transmitting the movement between the input shaft and the output shaft also belonging to the power converter, consisting of another set of gears and gives an one way coupling device similar to that described above, moves the output shaft (2) in a direction opposite to that of the input shaft (1) whereby the screw continues to rotate in the same unidirectional direction.

The tool object of this utility model is reversible so that if it is possible to loosen the screw, it is intended to turn it back to the tool. This way, what is to be done is to manually extract the handle from the end of the input shaft where it was before (4.1), and we put it at the opposite end (4.2) of the input shaft where it was above. The tightening cup is also in the form of the end (3.2) of the output shaft (2) where it was located and placing it at the opposite end (3.1 (2), so that, if it is to be applied to the input shaft, the movements described above, this input shaft, will transmit the movement to the output shaft, but at this time, the tightening cup in this order (3.1), is found to rotate unidirectionally in the opposite direction, which disclosed when it was at the front end (3.2).

In FIG. 2, there is shown a representation of the double-ratchet wrench key, in which the input shaft (1) and the output shaft (2) have a male key connection or bit in each of the two ends, although they can be female (4.1, 4.2, 4.3, 4.4) and not necessarily the socket key connections or coupling, in this figure we also see the housing (13).

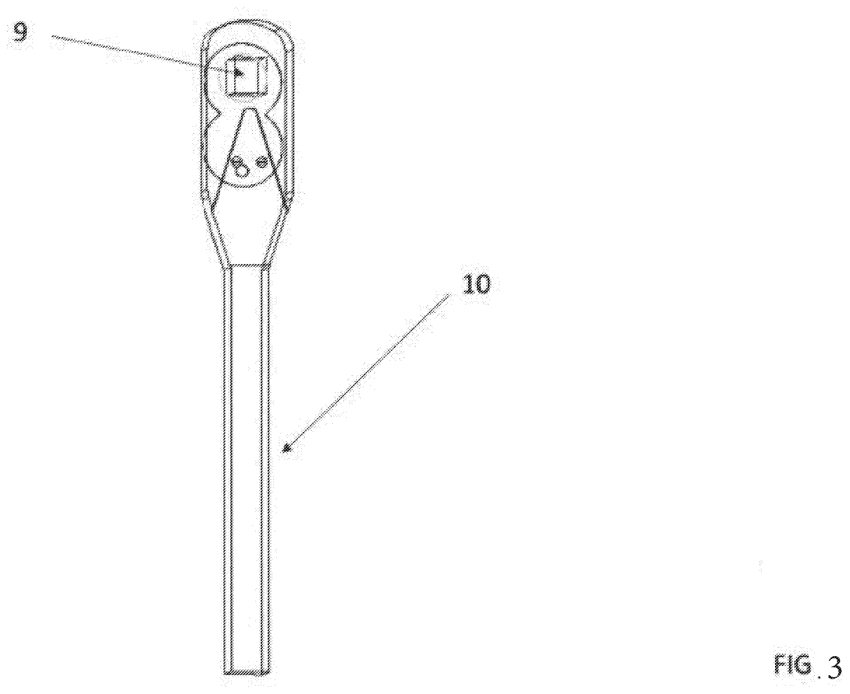

### FIG. 3

In FIG. 3, there is shown an embodiment of a new tool or handle, in which we have a socket in the female form of a cup key, which traverses the handle (10) from side to side. Necessary, in the event that there is a bi key system with four male connectors, shown in FIG. 2, in this case, the input shaft (1) would be slightly longer than the output shaft (2) (not shown in figure).

### FIG. 4

In FIG. 4, it is shown that we try to explain with parallel axes arranged so that they can draw a cross sectional plane that part of the two cylindrical axes. In FIG. 4, we have a cross sectional (5) plane containing the points (6) and (7) which are located in the middle of each of the two axes. (Stated another way, if the tool is cut in half the tool formed, by the area of the cutting plane 5, this cut, split in the middle, the two Shafts and the housing regardless of the length difference of one axis with respect to another).

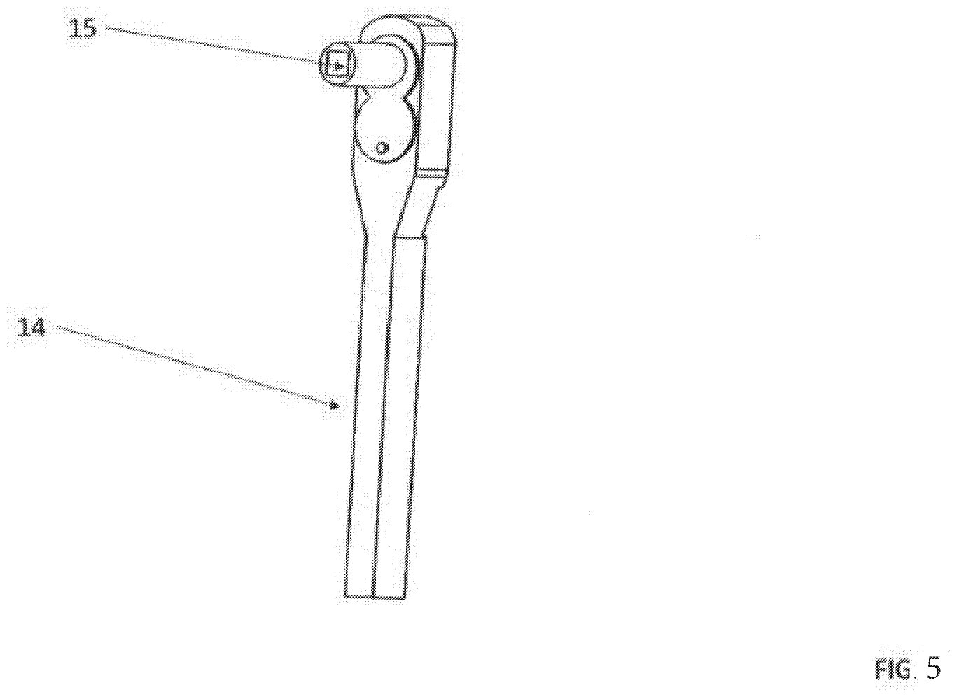

### FIG. 5

In FIG. 5, we can see a preferred form of performing a new handle (14), with a female socket connector (15), said adapter being used when using a cup key, either with a carriage or not, and the double-ratchet wrench key has male connections (3.1) at each of its ends.

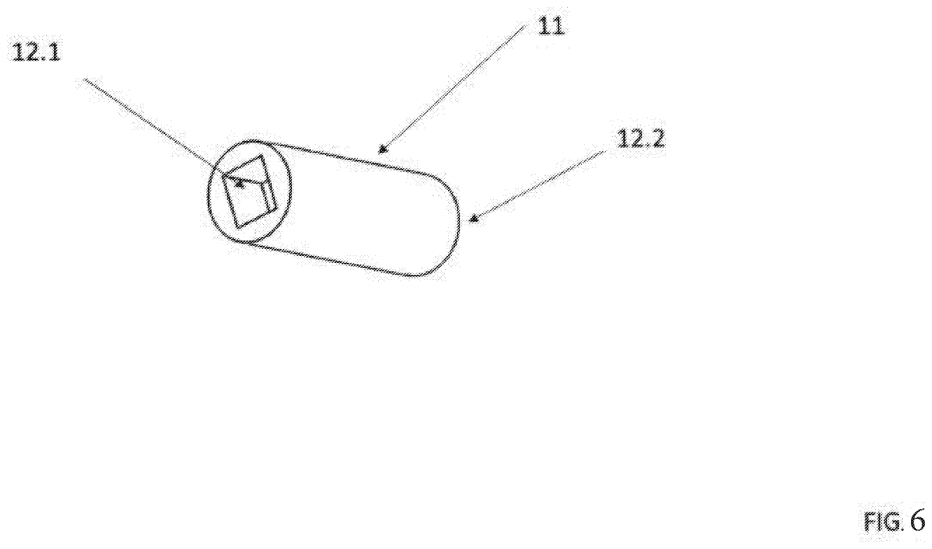

### FIG. 6

In FIG. 6, a female key adapter (11) is shown to be able to use an existing cup key handle with the turn selector of the locked cup key, which, although in this figure, is a cup key, may be another type of female coupling.

### Generalities

As mentioned above, these couplings can vary, we can have two male couplings on the output shaft and two female couplings on the input shaft. These shafts have a groove which allows a keyway to be made to clamp the gears, not shown.

The couplings can be female for punctures or nail drivers.

The gears making up the energy conversion system can have different transmission ratios, thus allowing, for example, to tighten a hexagonal head screw, to reduce almost in half the number of movements necessary to tighten or loosen with less effort.

The tool has a housing (13) with an ergonomic shape for manual gripping, which is divided into two parts at a minimum, an Upper and a lower part, which is closed with screws, and has four openings through which the two shafts run. When the two shafts are placed in the housing, if a cutting plane is drawn transversely by the half of the tool, formed by the two shafts and the carcass, this cutting plane also intersects the middle of the shafts and the housing.

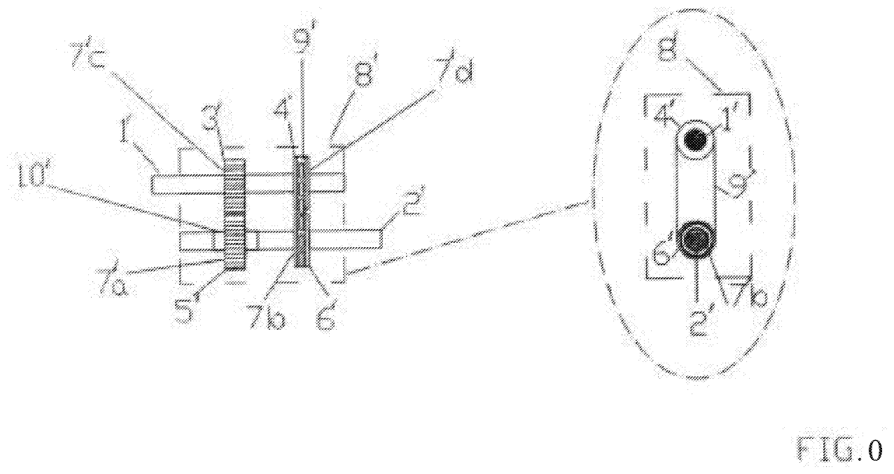

The housing also has sufficient spacing and dimensions, to house the energy converter, and to hold it, a third small axis with the inverter gear, in the event of not using chain (9′) (not shown in the figure). It can also have two smaller holes (8.5 and 8.6) in order to be able to place a third shaft which can have smaller dimensions (smaller diameter), which holds a pinion type gear which makes the turn inverter, rather than the use of a chain (9′ of FIG. 0).

The male bits can have the fastening beads for ratchet cups which commonly have the pins or male bits of the cup keys. The four ends of the shafts of the tool can have four female connectors so that they can be used by handles of

The invention relates to screw drivers with carriages having a female connector at its end, where the tips of different metrics are placed, or using a similar handle which can have a female key bit of carrying or cup, and a male adapter

This tool, object of this utility model, is not only used to use car key cups, but other types of vessels and connections at their ends that are of new construction.

The shafts can have a cylindrical, square or better shape. The housing is arranged so that the ends of the two shafts are separated there from and in a symmetrical manner.

The housing may have one or two additional openings, by which a third shaft is internally threaded with the reversing gear. If it has a more open opening, it has a holding support for holding and allowing the shaft to rotate which will be shorter than the input and output shafts.

The housing can be provided internally of a fastening means and which permits rotation to a third shorter axis and/or smaller diameter than the input and output shafts, in addition need not have more openings.

The coupling of the handle used can be in series, co axially or in parallel.

The output shaft (2) can be longer than the input shaft,

The output shaft is moved by rotation unidirectionally regardless of the direction of rotation of the movement applied to the input shaft.

The four ends of the two shafts are outside the housing in order to couple the different elements.

The housing has a hollow with a plug by means of introducing oil or fluid for grease or lubricating.

1. A tool for tightening or loosening different elements unidirectionally, the tool comprising:
an input shaft (1) in which the force at both ends is applied, and
an output shaft (2), which transmits motion by both ends, the input shaft is parallel to the output shaft and are arranged in shape, which can be cut in half using a cross sectional plane (5) independent of the length thereof,
a first and a second transmission devices for moving one axis with respect to the other, the first transmission device includes two sprocket gears (3′, 5′), which reverse a direction of rotation between the two shafts, the second transmission device includes a gear (4′, 6′) reversing system for moving the two shafts in the same direction and two ratchet devices with locking fingers (7b′, 7c′) located between the sprocket gears and the shafts, so that the gear reversing system has an one way coupling device (7c′) on the input shaft while the transmission device has a turn reversing system for moving both axes in the same direction of rotation has another one way coupling device (7b′) in one of the gears; wherein the two ratchet devices (7b′, 7c′) are arranged so that they are locked in opposite rotational directions with respect to each other, both shafts have at their ends a coupling device in order to couple the different elements, both to move the input shaft, and to couple the elements to be moved, on the output shaft;
an ergonomic shaped housing for manual gripping, with four openings by which the input shaft and the output shaft runs, the ends of the shafts being outside the housing so that a handle is coupled at either end of the input shaft to rotate 360 degrees,
wherein an inner surface of the housing houses the two shafts and the two axes of transmission between the two axles;
wherein the tool is arranged to be uses a cross sectional plane that is part of the housing and the shafts with the outside said housing, a handle is placed at either end of the input shaft to rotate 360 degrees.

2. The tool according to claim 1, wherein the reversing system moves the two shafts in the same direction and includes two spur gears, and a third gear which reverses the direction of rotation between them placed on a third axis.

3. The tool according to claim 1, wherein the reversing system includes two pinions (4′ and 6′) with a transmission chain (9).

4. The tool according to claim 1, wherein the input shaft (1) is of the same size as the output shaft.

5. The tool according to claim 1, wherein the input shaft is larger than the output shaft

6. The tool, according to claim 1, wherein the couplings of the two ends of both shafts (1,2) have male and/or female couplings.

7. The tool according to claim 1, wherein the transmission devices have a different transmission ratio, torque multipliers, reducers, etc.
